(19) United States
(12) Patent Application Publication
(10) Pub. No.: US 2008/0130782 A1
(43) Pub. Date: Jun. 5, 2008

(54) System for using TV/radio stations for broadcasting digital codes in order to automatically activate a receiver to notify the public of emergency information

(76) Inventors: Kenneth John Lannes, New Orleans, LA (US); Kim Dayne Jovanovich, New Orleans, LA (US)

Correspondence Address: Kenneth John Lannes, Apt. 2525, 3201 Rue Parc Fontaine, New Orleans, LA, 70131, US

(21) Appl. No.: 10/701,514

(22) Filed: Nov. 6, 2003

(51) Int. Cl. H04L 27/00

(52) U.S. Cl. 375/295

(57) ABSTRACT

The present invention provides a means of using transmitted radio and/or TV signals to automatically turn on a receiver in order to broadcast emergency information. It is comprised of a radio or TV transmitter that has the capability of broadcasting a digital code, and a receiver capable of interpreting the code and automatically turning on if the code tells it to do so.

### BRIEF SUMMARY

The system was designed to provide 24 hour emergency notification capability on a local level. There are several systems that provide such capability, but most are based on national emergency systems. This system gives control to local broadcasters, more closely in communication with the viewing/listening community. Furthermore, this system has over 60,000 codes which can be broadcast. These codes are broadcast using TDM (time division multiplexing) and allow the broadcaster to divide up the viewing/listening area with much greater geographical resolution than what other nationwide systems allow.

### BACKGROUND OF THE INVENTION

There have been several emergency notification systems developed in the past. First was Conelrad. A recent version is the EBS (emergency broadcast system). This was set up by the U.S. government and was originally intended to have an automated turn on feature. However, for whatever reason, the proliferation of the system, especially pertaining to availability to the general public, has not been widespread. It is not known if one can buy a radio/TV that would automatically turn on based on the transmitted signal of the old EBS system.

The key to the proposed current invention, and its potential commercial success, is the incredible simplicity of its TDM modulation approach. Other patents have been filed for broadcasting emergency or “hidden” information using radio/tv signals, but adopt much more complex and costly modulation schemes for transmitting the data. They differ from the current submitted invention in the following manners:

U.S. Pat. No. 4,037,158 is a design concerning two-way FM operation over a single channel with transmit/receive detection. The current proposed invention is only one way operation.

U.S. Pat. No. 4,388,493 is a design concerning the use of sending information through an FM channel by means of a low frequency tone whose broadcast and detection involves sum/difference encoding of the left and right channels and filtering at the receiver. The current proposed invention does not require any filtering or removal of a “hidden” or modulated tone outside of the normal channel bandwidth.

U.S. Pat. No. 4,398,304 is a design which is basically a scanning radio receiver that searches for AM and FM signals. The current proposed invention does not have a scanning feature and is preset to receive a certain frequency.

U.S. Pat. No. 4,450,589 is very close to the current invention except that it's modulation technique is much more complex using subcarriers to transmit the information without interrupting the voice signal. The current invention does not concern itself with subcarrier encoding and deliberately interrupts the voice signal.

U.S. Pat. No. 4,476,581 uses a subcarrier modulation technique not used by the current invention. NOAA has set up an automated weather radio system, which does have automatic turn on capability and geographical division capability. However, when interviewing users of the current system, several users have indicated they eventually turn off the system because the geographical resolution is not high enough and they routinely get warnings of events that do not threaten their area.

Recently the U.S. government has added the EAS (emergency alarm system) to the NOAA system. The EAS broadcasts over the same channels as NOAA does and provides information about other emergencies such as earthquakes, fires, chemical spills, etc. However, the NOAA EAS does not have the geographical resolution of the proposed system, and it is not believed that local emergency information can be handled and decided upon at the national level, as quickly and accurately as it can be done on the local level.

Several other systems are being developed based around current phone systems, cable systems, and internet access systems. The current invention is superior to all of these for the following reasons:
1. Current phone systems, whether cellular or land line, are not capable of handling 100% traffic at the time of an emergency, 9/11 proved this,
2. The proposed system requires no technician to visit a site for installation,
3. The proposed system requires no monthly fees,
4. The proposed system requires no installation of an infrastructure such as cable or optical fiber, and makes use of an existing infrastructure that has been in place for over 60 years, and is “tried and true”,
5. The proposed system has no software menus to scroll through and no software to learn, which is an important feature for senior citizens or the mentally disabled.

U.S. Pat. No. 4,517,562 relates to the communication of customers attached to a power grid, and uses a more complex scheme of subcarrier modulation.

U.S. Pat. No. 4,518,822 uses primary and secondary modulation schemes to reestablish telephone communications during emergencies. The current proposed invention does not concern itself with any link of telephone service.

U.S. Pat. No. 5,065,398 is primarily concerned with subdividing data into packets, and then using TDM for satellite communications.

U.S. Pat. No. 5,463,356 is a design, which, by using a “comb generator”, creates carriers for all the FCC stations in the FM broadcast band. These carriers can then all be modulated at the same time so that all stations would broadcast the same emergency message. This is very unlike the approach of the current invention.

U.S. Pat. No. 5,708,662 is very close to the current invention but uses a quite complex modulation technique. The current invention uses a very simple TDM scheme, which greatly simplifies the receiver and the cost of the receiver.

U.S. Pat. No. 5,119,503 is similar to the current invention but broadcasts text messaging using a complicated modulation technique to encode the data. The current invention uses a very simple TDM scheme, which greatly simplifies the receiver and the cost of the receiver and does not concern itself with encoded text messaging.

U.S. Pat. No. 5,956,628 is designed around the concept of using text-based information to broadcast. The present proposed invention does not use text based messaging.

U.S. Pat. No. 6,239,748 develops a technique for measuring phase delays between receiving stations of FM wireless phones in order to fix a position on the phone user.

### BRIEF DESCRIPTION OF DRAWINGS

FIG. 1—Block diagram of the system

FIG. 2—Block diagram of the receiver

### DETAILED DESCRIPTION

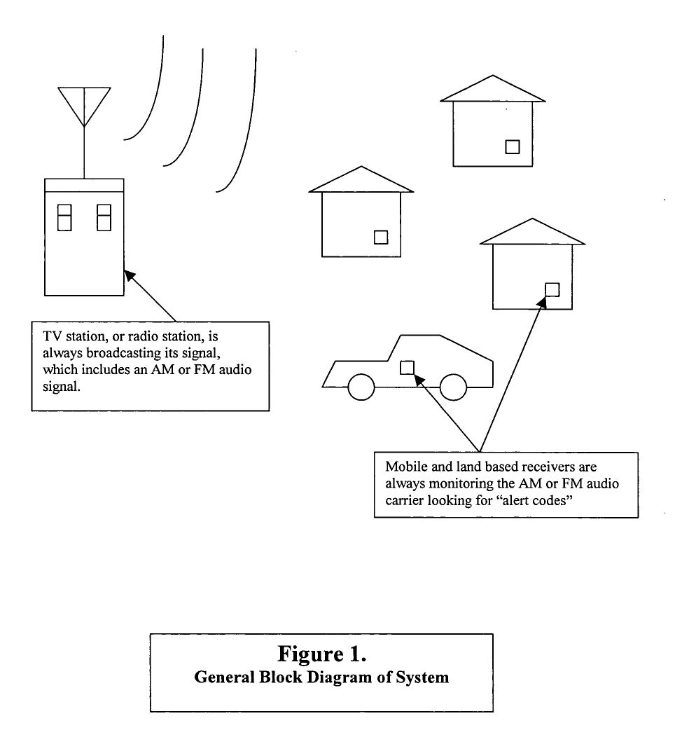

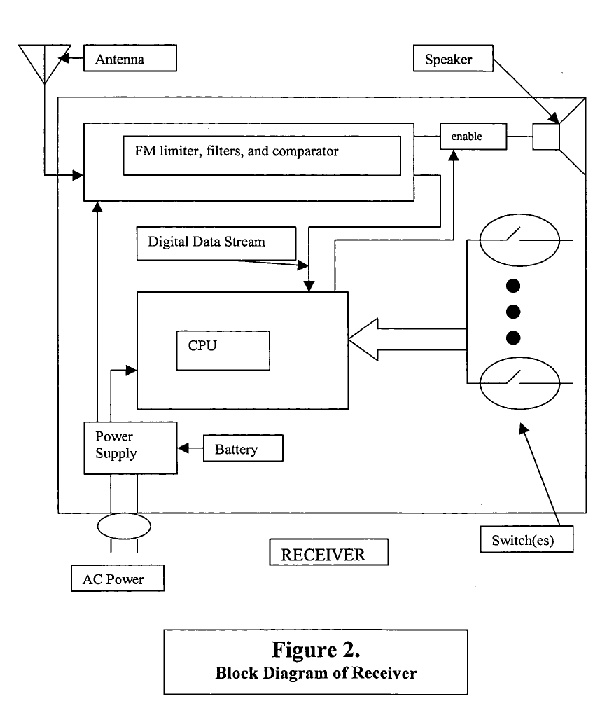

FIG. 1 shows the general block diagram of the system. To understand the system, it is best to walk through how the system is activated: When the TV/Radio station deems it has information worthy of constituting an emergency, it sends out a digital code through its audio carrier. This digital code is TDM'ed (time division multiplexed) into the audio carrier. This is without a doubt the simplest way to do this and does not cause a problem to the listener/viewer because the programming is getting ready to be interrupted anyway to broadcast the emergency information. Furthermore, the code is broadcast in a relatively short period of time. Audio listening tests of this code show it is not annoying to the listener/viewer, especially compared to the “attention tones” most stations send out anyway to let you know there is an emergency message coming up, or the old EBS tones. The codes contain several characteristics of the emergency information depending on what bit code/number is sent out. The characteristics are: what geographical area the broadcaster is trying to reach, whether or not the viewer should turn on their TV for video trailer information, and whether or not the TV/Radio audio signal will be piped directly into the receiver for the listener/viewer to hear. The codes may be sent out more than once before an emergency for redundancy. In essence, the current proposed invention simply interrupts the analog voice information of an AM radio or FM radio/TV (FIG. 2 doe not show AM version) tation and injects it's own digital AM or FSK bit pattern representing a code (FSK is Frequency Shift Key, which is the designation for sending digital bits through an FM system, and AM refers to amplitude modulation for AM radio). If the receiver is looking for the AM or FSK data stream, it can recognize the correct code and act upon it. This is much like many modems but the proposed invention is wireless and uses the existing infrastructure of licensed FCC TV/radio stations to send emergency information. This is a huge cost savings in developing the system.

Once the signal is sent out, the receiver recognizes the code and turns on (see FIG. 2 for the receiver). The RF receiver is always on, tuned to the audio carrier, and looking for the correct code. Every fraction of a bit length of the code (which could be, but is not limited to, for example 0.125 milliseconds) the incoming received data is moved through a shift register and a comparison of the existing bits in the register is done. The code may, or may not, contain a start/stop bit. If a match is found, the microprocessor performs the necessary instructions. The determination of what bit pattern (code) to look for is based on the position of one or more switches. The position of this switch is set by the user, sampled by the microprocessor, and designates what geographical location the user is in. In addition to geographical location, if a TV station is being used, there are also another set of codes for each location that specify whether or not the user should simply turn on their TV to the transmitting channel (this is communicated by a beeping or a voice chip), or in extreme emergencies, the anchor people for that station would automatically start broadcasting through the radio receiver since the radio is already tuned to the audio carrier.

There is also a master code, which when sent out, all of the receivers would recognize it and turn on. Because of the large amount of possible codes, geographical locations can also be grouped in counties or sub-counties and represented by separate codes. This eliminates the need to send out 10 different codes if 10 locations close together need to be alerted.

I claim:

1. A signal containing a bit code,
a. which is broadcast from a radio or TV transmitter, using an AM or FM scheme, time division multiplexed into the broadcast information, and meets the FCC bandwidth requirements for such a system.
b. which provides information about impending emergencies to listeners or viewers within certain geographical areas, the said geographical areas of which are designated by the bit code.

2. a receiver circuit capable of receiving the RF energy of said signal mentioned above in #1, and capable of generating a demodulated AM or FM signal based on modulated information of said signal, which will be sent to an amplifier and speaker, self contained in the receiver, for the user to hear information with,

3. said receiver circuit also contains a processor which accomplishes the following:
a. reads the position of one or more switches in the receiver, interfaced to the user, which designate the bit codes to recognize or ignore,
b. recognizes said bit code, based on said switch positions, and activates a beep or voice chip, instructing user what to do, or provides an audio output of the AM or FM signal said receiver is tuned to, in order to provide emergency information to the user.
c. may drive an optional visual display.
